(19) United States
(12) Patent Application Publication
(10) Pub. No.: US 2010/0136227 A1
(43) Pub. Date: Jun. 3, 2010

(54) LENS HANDLING IN AUTOMATED LENS COATING SYSTEMS

(75) Inventors: David R. Kirchoff, Brooklyn Park, MN (US); Mike Tschida, Oakdale, MN (US); Chuck Boho, Coon Rapids, MN (US); Cary Hostrawser, Dayton, MN (US); Mike Clyne, Otsego, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: THE WALMAN OPTICAL COMPANY, Mnneapolis, MN (US)

(21) Appl. No.: 12/557,308

(22) Filed: Sep. 10, 2009

Related U.S. Application Data
(60) Provisional application No. 61/095,640, filed on Sep. 10, 2008.

(51) Int. Cl. B05C 11/00; B05D 5/06

(52) U.S. Cl. 427/164; 118/708; 414/800

(57) ABSTRACT

A lens coating system, which includes a gripper assembly for transferring and loading lenses, further includes one or more features to facilitate improved lens handling within the system. The one or more features includes a sensor assembly that is adapted to detect whether a single blocked lens or a pair of blocked lenses is being loaded by the gripper assembly into a spindle assembly of the system, and/or a sensor assembly that is adapted to detect a displacement of a lens holding element, from which lenses are transferred, by the gripper assembly, when impinged upon by the gripper assembly.

### CROSS-REFERENCE TO RELATED APPLICATION

This application claims priority under 35 U.S.C. §119(e) to U.S. provisional application No. 61/095,640, filed Sep. 10, 2008, which is hereby incorporated by reference in relevant part.

### TECHNICAL FIELD

The present invention pertains to automated lens coating systems, and more particularly to the handling of the lenses in these systems.

### BACKGROUND

The optical, and particularly eyeglass, industry has made considerable progress in the use of coatings to improve the surface properties of desired substrate materials, such as polycarbonates. Common coatings include scratch resistant coatings and abrasion resistant coatings. UV-cured scratch resistant coatings are typically applied by a spin technique, in which the coating composition is applied to a single major surface, or the “backside”, of the lens, which in turn, becomes the inward facing surface in a pair of eyeglasses.

An automated system, which employs the spin technique for coating lenses, is described in a co-pending and commonly-assigned patent application, which has the International publication number WO 2006/099012, and is hereby incorporated herein, by reference. Some embodiments of the aforementioned automated system are adapted to transfer a single lens or a lens pair into and out from various stations of the system, in sequence, which stations include a washing station, followed by a coating station, followed by a curing station. WO 2006/099012 describes some preferred embodiments of the system as having the capability to receive, in sequence, each of a plurality of single lenses, and/or lens pairs, and to transfer each of the plurality into a separate station of the system, such that, when a first single lens or lens pair is being cured in the curing station, after having been washed and coated in the system, a second single lens or lens pair is being coated in the coating station, after having been washed, and a third single lens or lens pair is being washed in the washing station. Although the systems and associated methods described in WO 2006/099012 increase processing efficiency for lens coating, there is still a need for improvements, in order to better manage lens handling within such systems.

### BRIEF SUMMARY

Embodiments of the present invention encompass features and methods, which facilitate improved lens handling in automated lens coating systems. According to some embodiments of the present invention, a lens coating system includes a sensor assembly, which is adapted to detect whether a single blocked lens or a pair of blocked lenses is being loaded, via a gripper assembly of the system, into a spindle assembly of the system; one or more processing stations of the system may then be activated based upon the detection. According to some embodiments, wherein the spindle assembly includes a pair of cups, that are each adapted to hold a blocked lens, via a vacuum, the sensor assembly is coupled to the spindle assembly for activating the vacuum according to the detection. Alternately, or in addition, some additional embodiments of the present invention include a sensor assembly, which is adapted to detect a displacement of a lens holding element of the system, when the lens holding element is impinged upon by the gripper assembly, as the gripper assembly is moving to transfer one or more lenses either to, or from, the lens holding element.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIG. 1 is a perspective view of an enclosure for a lens coating system, which may be employed by some embodiments of the present invention.

FIG. 2 is a top plan view of a portion of the lens coating system.

FIG. 3A is perspective view of a tray for holding a single blocked lens or a pair of blocked lenses.

FIG. 3B is a cross-section view of an exemplary blocked lens.

FIG. 3C is a perspective view of a pick and place unit, or gripper assembly, which may be employed by some embodiments of the present invention.

FIG. 3D is an enlarged perspective view of a pair of grippers of the gripper assembly of FIG. 3C.

FIG. 4A is a perspective view of a spider assembly, which may be employed by some embodiments of the present invention.

FIG. 4B is a side elevation view of a spindle assembly, which may be mounted on an arm of the spider assembly.

FIG. 4C is a cross-section view of a cup of the spindle assembly holding a blocked lens, according to some embodiments of the present invention.

FIG. 4D is a side elevation view of a portion of the lens coating system, according to some embodiments of the present invention.

FIGS. 5A-B are a perspective view and a front elevation view, respectively, of a shuttle assembly of the lens coating system, according to some embodiments of the present invention.

FIG. 6A is a perspective view of a coating compartment of a coating station, which may be employed by some embodiments.

FIG. 6B is perspective view of a flow meter which may be included in the coating station, according to some embodiments of the present invention.

FIGS. 7A-B are a perspective view and a side elevation view of a curing station, which may be employed by some embodiments of the present invention.

FIG. 8A is a perspective view of a reorientation assembly, which may be employed by some embodiments of the present invention.

FIG. 8B is a front elevation view of the reorientation assembly of FIG. 8A.

FIG. 8C is a cross-sectional view of the reorientation assembly of FIG. 8A, taken along line A-A of FIG. 8B.

FIG. 9A is a perspective view of a gripper assembly, which may be employed by some embodiments of the present invention.

FIG. 9B is a top view of the gripper assembly of FIG. 9A.

FIG. 9C is a cross-sectional view of the gripper assembly of FIG. 8A, taken along line A-A of FIG. 9B.

FIG. 9D is a cross-sectional view of the gripper assembly of FIG. 8A, taken along line B-B of FIG. 9B.

### DETAILED DESCRIPTION

The following detailed description is exemplary in nature and is not intended to limit the scope, applicability, or configuration of the invention in any way. Rather, the following description provides practical illustrations for implementing exemplary embodiments of the present invention. Examples of constructions, materials, dimensions, and manufacturing processes are provided for selected elements, and all other elements employ that which is known to those of skill in the field of the invention. Those skilled in the art will recognize that many of the examples provided have suitable alternatives that can be utilized.

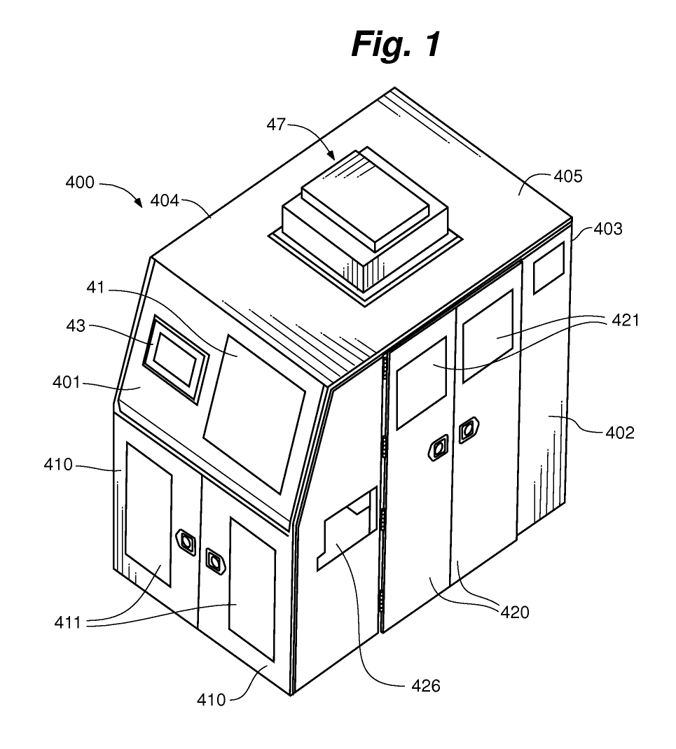

FIG. 1 is a perspective view of an enclosure 400 for a lens coating system.

FIG. 1 illustrates enclosure 400 including a front panel 401, two opposing side panels 402, 404, a rear panel 403, and a top panel 405, in which a HEPA filter unit 47 is mounted. Front panel doors 410 and side panel doors 420 may provide access to within enclosure 400, and each are shown including optional windows 411 and 421, respectively. An electronics panel of the coating system may be housed within a rear portion of enclosure 400, being accessible through rear panel 403. Another window 41 is shown in front panel 401 alongside a control and display panel 43, thus an operator may see within enclosure 400 and utilize panel 43 to provide any necessary input to the system. According to an exemplary embodiment of the present invention, panel 43 includes a start button, for activating the coating system, and trouble shooting features, for example, displays indicating types and locations of faults or errors within the system, as picked up by a variety of sensors located throughout the system, and a manual override of at least a portion of the automatic control of the system.

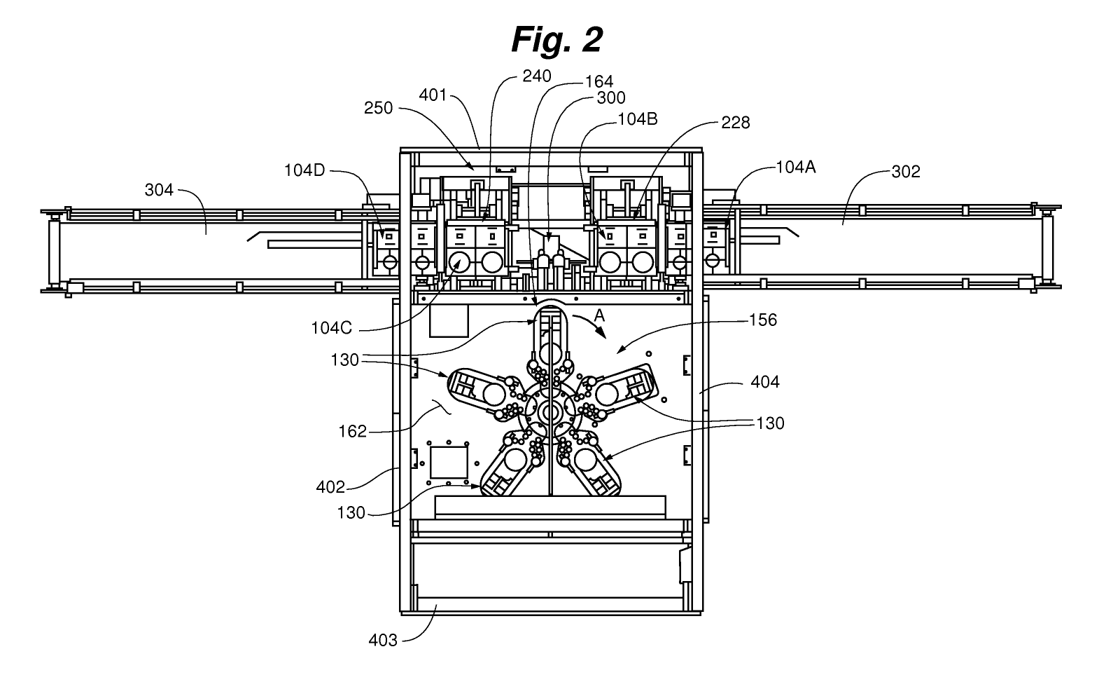

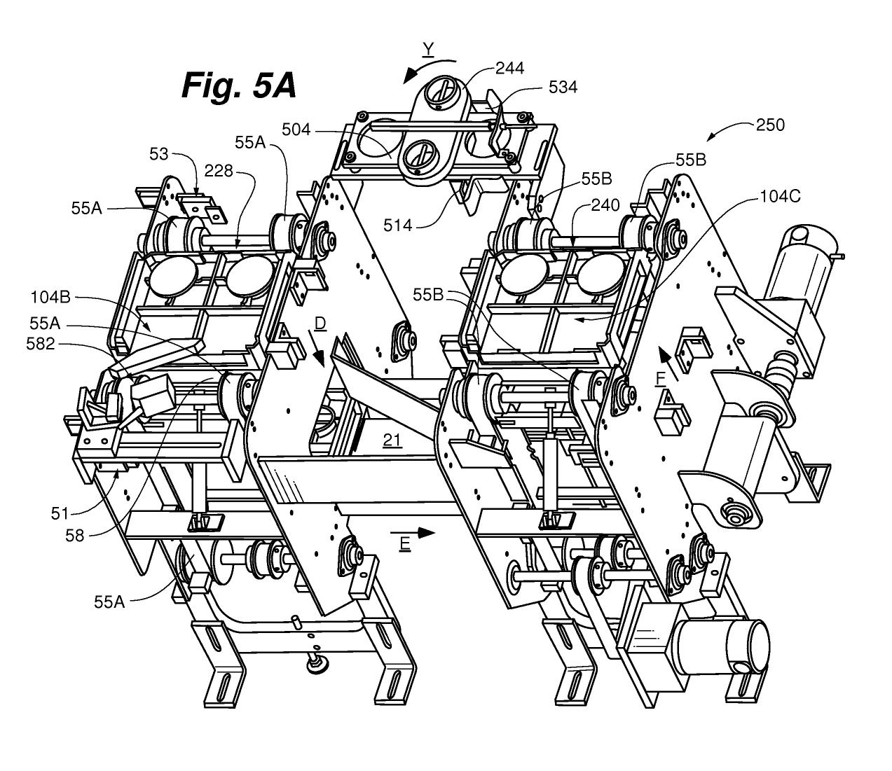

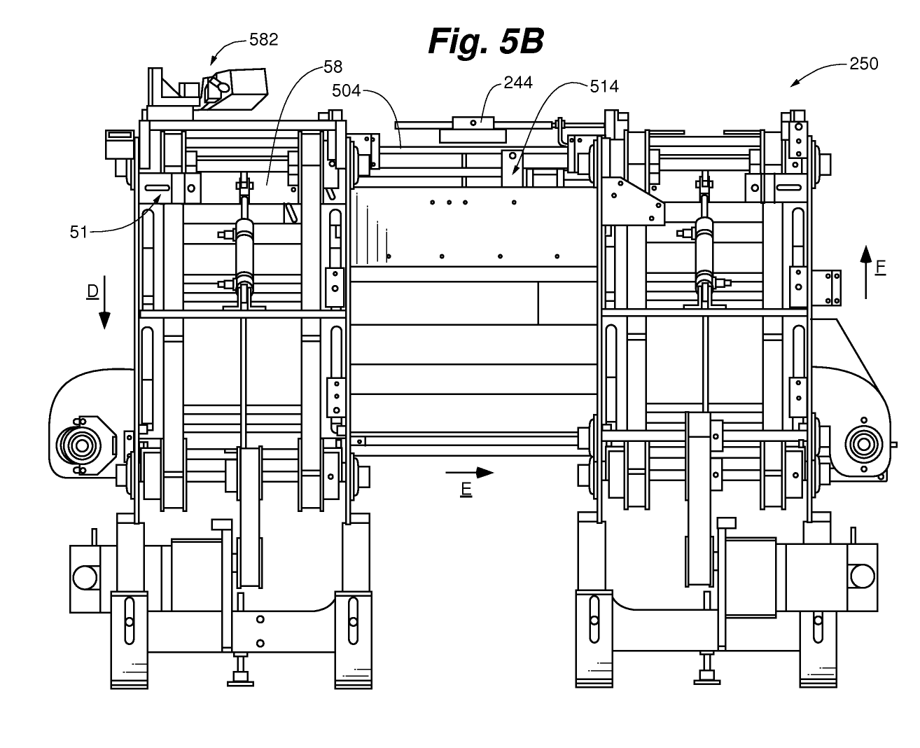

FIG. 2 is a top plan view of a portion of the lens coating system, wherein top panel 405 of enclosure 400 has been removed. FIG. 2 illustrates the lens coating system including a shuttle assembly 250, which is housed in a front end portion of enclosure 400. FIG. 2 further illustrates an input conveyor 302 feeding into shuttle assembly 250, and an output conveyor 304 feeding out from shuttle assembly 250. According to the illustrated embodiment, shuttle assembly 250, which will be described in greater detail, below (in conjunction with FIGS. 5A-B), receives trays 104, one by one, from input conveyor 302, onto an input platform 228 of shuttle assembly 250, where a single lens, or a lens pair, is transferred, from each of trays 104, into the coating system; shuttle assembly 250 then transfers trays 104, one by one, over to an output platform 240, where each tray 104 receives back, from the coating system, the same lens or lens pair, after the lens or lens pair has been coated in the system. With reference back to FIG. 1, in conjunction with FIG. 2, each tray 104 is moved from output platform 240, through an exit opening 426 in enclosure and onto output conveyor 304. In FIG. 2, tray 104A is shown at an end of conveyor 302 in an entrance opening of enclosure 400, ready to be fed into shuttle assembly 250, tray 104B is shown in a first position, on input platform 228 of shuttle assembly 250, tray 104C is shown on an output platform 240 of shuttle assembly 250, and tray 104D is shown within exit opening 426 of enclosure 400, at an end of conveyer 304.

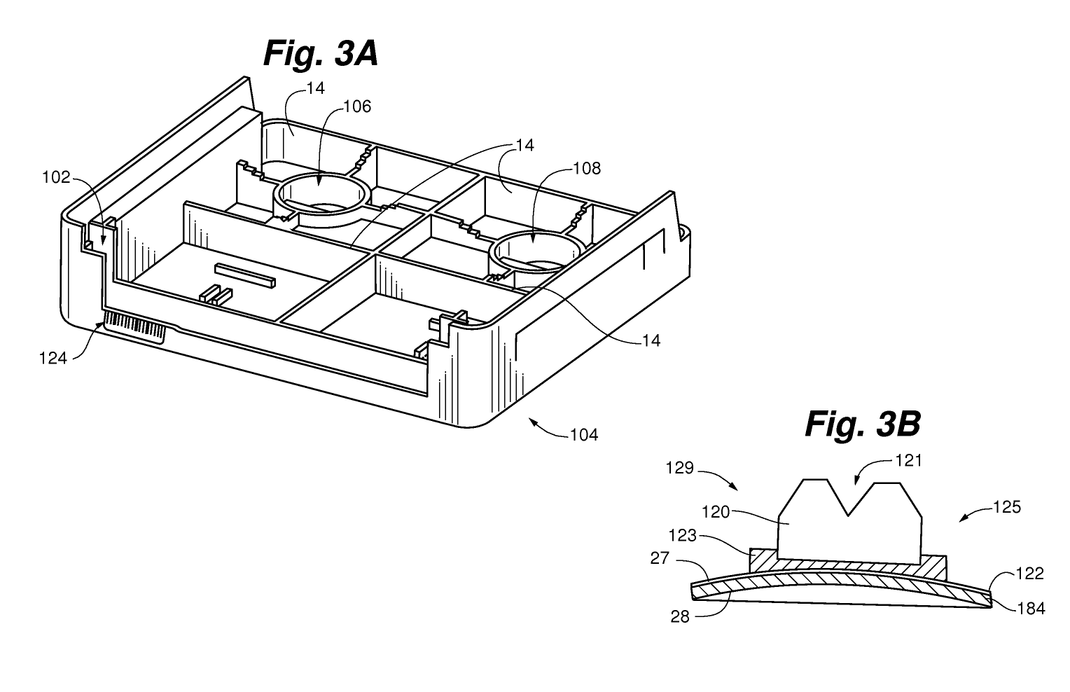

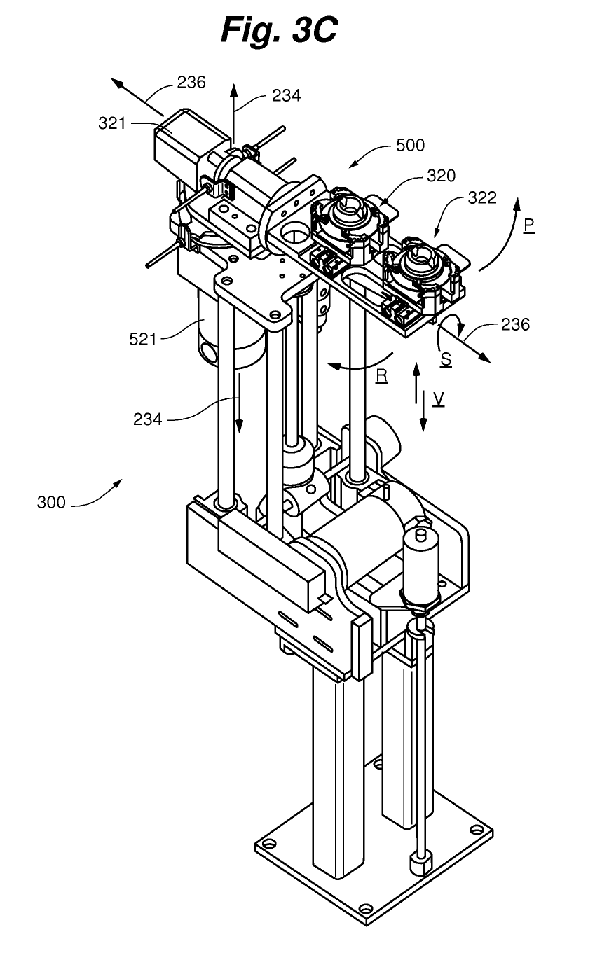

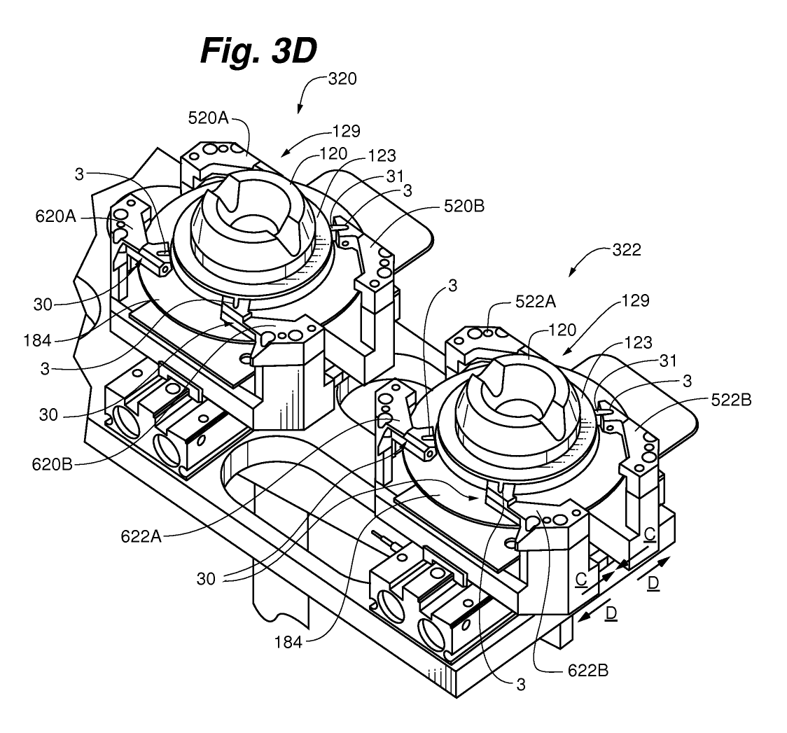

FIG. 3A is a perspective view of one of trays 104; and FIG. 3B is a cross-section view of an exemplary blocked lens 129, which may be held by tray 104, for conveyance into and out from the lens coating system. FIG. 3A illustrates tray 104 including a first cavity 106, for example, to hold blocked lens 129, and a second cavity 108, which may hold another, similar, blocked lens, to make up a lens pair. FIG. 3B illustrates blocked lens 129 including a lens 184 fixed to a mounting block assembly 125, which includes a mounting block 120 and an intermediate member 123 that fixes mounting block 120 to a first major surface 27 of lens 184; an optional protective film 122 is shown intervening between surface 27 and intermediate member 123. Lens 184 would have been fixed to mounting block assembly 125 as a preliminary step in a process to form lens 184; mounting block assembly 125 provides a means for grasping lens 184 during grinding, polishing, and cleaning of a second major surface 28 of lens 184. Intermediate member 123 may be one or a combination of various materials; in some cases, member 123 comprises a metal alloy that is cast in place between mounting block 120 and film 122; alternately, member 123 comprises an adhesive or a wax, which may not require protective film 122. Each cavity 106, 108 of tray 104 may be dimensioned to receive mounting block 120, such that second major surface 28 of each lens 184 faces outward from tray 104. To assure that each blocked lens 129 is held in a stable prescribed orientation within tray 104, each cavity 106, 108 may include a feature interfacing with a notch 121 in mounting block 120. Prior to transporting a single lens or lens pair, for example, one or two of blocked lens 129, into the coating system, for example, via input conveyor 302, tray 104 may have been used to transport the single lens or lens pair between other lens processing systems, for example, between a grinding system and a polishing system.

In some embodiments, tray 104 may move through the lens coating system stacked upon an additional tray. The lower tray can contain, e.g., glasses frames and other hardware. Moving the stacked trays together can assist manufacturers in keeping corresponding components together for later processing. In embodiments in which stacked trays are moved together, other components of the lens coating system (e.g., shuttle assembly components) can be modified to accommodate the stacked trays.

FIG. 3A further illustrates tray 104 including an optional receptacle 102 to hold an information card, which may include information, for example, pertaining to grinding parameters and/or to a type of coating, to guide the processing of lenses held in tray 104. Alternately, or in addition, a bar code sticker 124 may be attached to a side of tray 104, or to the information card held in receptacle 102. A bar code reader may be included in the coating system to provide for the automatic transfer of pertinent information to one or more processing stations within the coating system, as will be described in greater detail, below.

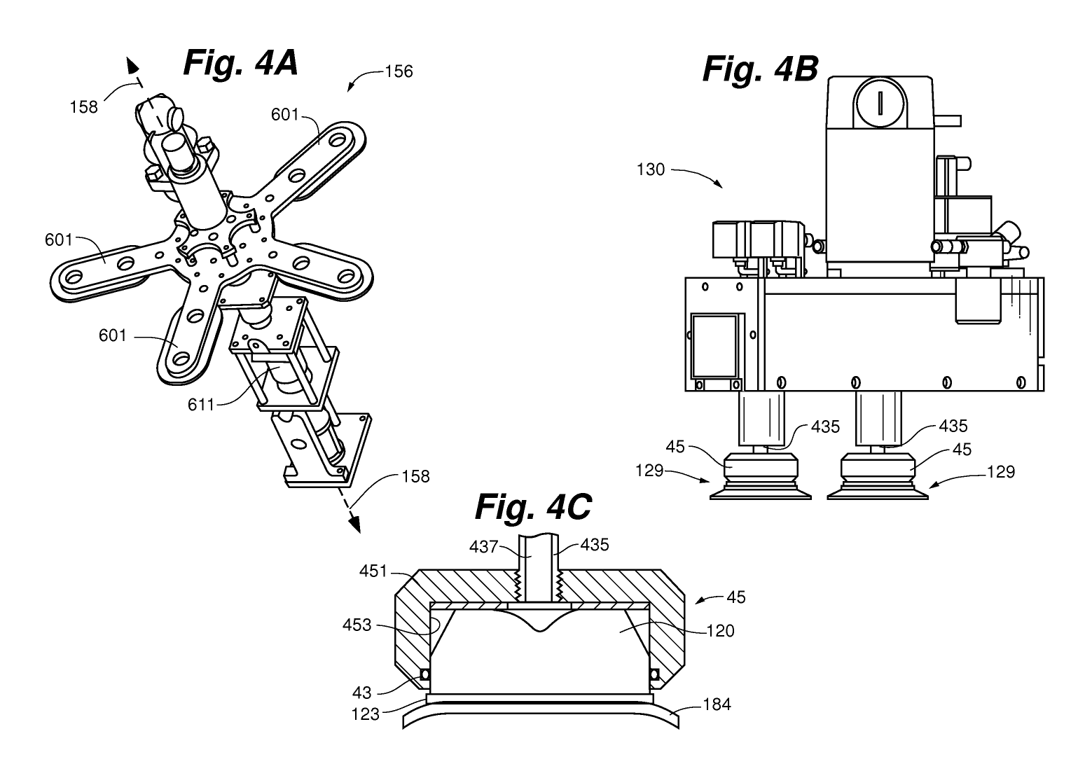

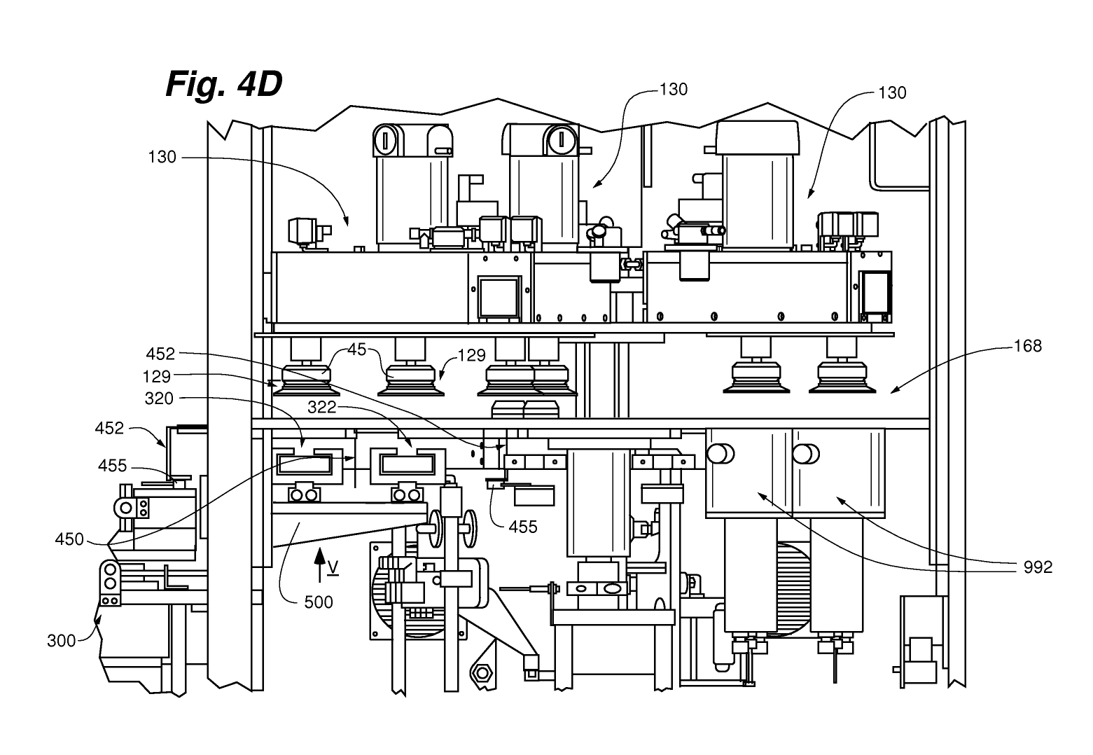

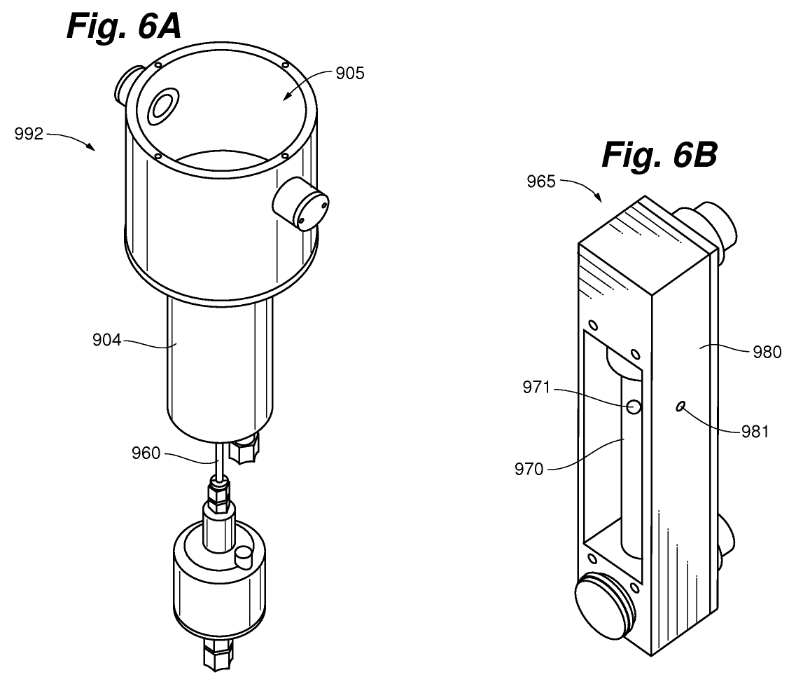

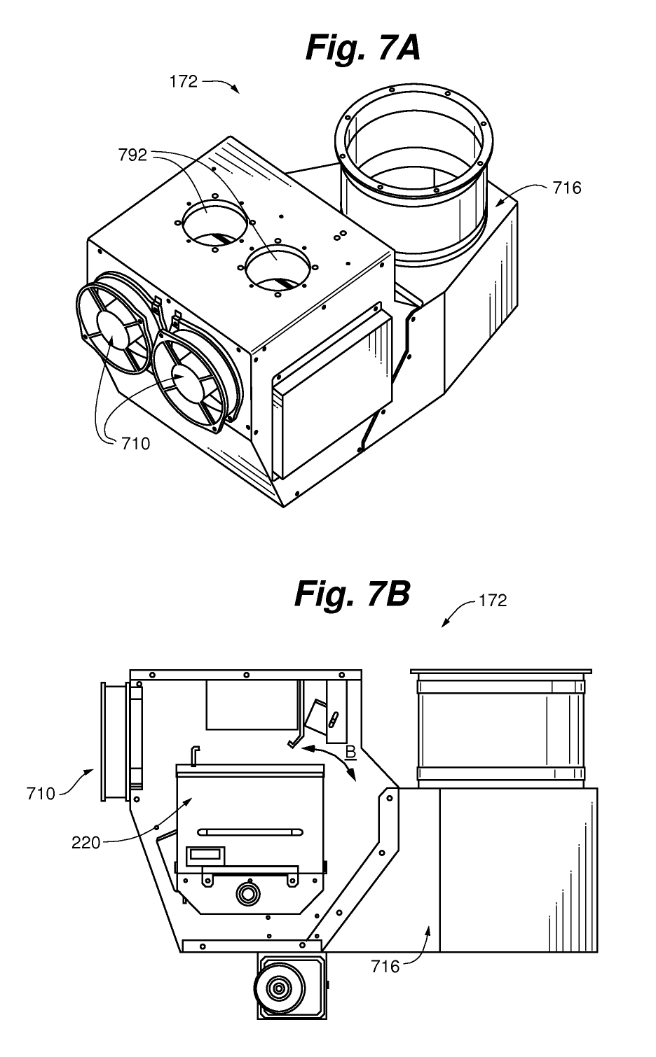

With reference back to FIG. 2, the lens coating system further includes a pick and place unit, or a gripper assembly 300, which is positioned between input platform 228 and output platform 240 of shuttle assembly 250, and a spider assembly 156, which is housed within a central portion of enclosure 400, and on which a plurality of spindle assemblies 130 are mounted. Each spindle assembly 130 is adapted for holding a single blocked lens 129 or a blocked lens pair, which has been transferred thereto, by gripper assembly 300, from each tray 104, at pickup point 164; spider 156 rotates, per arrow A, to position each spindle assembly 130 at each of various processing stations of the coating system, which are located below a deck 162 of the system. After spider 156 rotates each spindle assembly 130 to each processing station of the coating system, spider 156 returns each spindle assembly 130, in sequence, back to pick-up position 164, for transfer of blocked lens(es) 129 back to gripper assembly 300. Spindle assemblies 130 will be described in greater detail, below (in conjunction with FIGS. 4A-C), as will two processing stations of the coating system (in conjunction with FIGS. 6A-7B), one for coating and one for curing.

FIG. 3C is a perspective view of gripper assembly 300, which may be employed by some embodiments of the present invention; assembly 300 is shown isolated from the rest of the coating system, for clarity in illustration. FIG. 3C illustrates gripper assembly 300 including a cantilever arm 500, on which a first gripper 320 and a second gripper 322 are mounted. With reference to FIG. 3D, which is an enlarged perspective view of grippers 320, 322, each gripper 320, 322 includes a first pair of gripper fingers 520A-B, 522A-B, respectively, opposing a second pair of gripper fingers 620A-B, 622A-B, respectively, each slideably mounted to open and close, per arrows 0 and C, respectively, around mounting block assemblies 125 of blocked lenses 129, for example, via pneumatic actuation. Of course, other types of grippers may be employed by embodiments of the present invention. FIGS. 3C-D show grippers 320, 322 grasping blocked lenses 129 such that lenses 184 are disposed below gripper fingers 520A-B, 620A-B, and 522A-B, 622A-B. Grippers 320, 322 are further shown being oriented and positioned to face upward toward one of spindle assemblies 130, which is positioned at pick-up position 164 (FIG. 2), in order to load blocked lenses 129 into the spindle assembly. With further reference to FIG. 3C, it should be appreciated that cantilever arm 500 rotates about an axis 236, per arrow S, for example, being driven by a gear motor 321, and about an axis 234, per arrow P, for example, being driven by a motor 521, to an orientation, wherein grippers 320, 322 are positioned over tray 104B at input platform 228 (FIG. 2), and are oriented to face downward, in order to pick up blocked lens(es) 129 from tray 104B. Likewise, arm 500 rotates about axis 236 and about axis 234, per arrow R, to an orientation in order to return lens(es) to tray 104B, which has been moved to output platform 240, as will be described in greater detail below. It should be noted that the design and function of the illustrated embodiment of gripper assembly 300 is similar to that described for the pick and place unit in the aforementioned, incorporated-by-reference patent application publication WO2006/099012.

With further reference to FIG. 3D, each gripper finger 520A-B, 620A-B, 522A-B and 622A-B includes a slot 3, in which a blade member 31 is held, for example, via a set screw. A surface, preferably serrated, of each blade member 31 interfaces with an outer perimeter surface of intermediate member 123 of mounting block assembly 125, when opposing pairs of fingers 520A-B, 620A-B, 522A-B and 622A-B are closed, in order to grasp blocked lens 129. Referring back to FIGS. 3A-B, in conjunction with FIG. 3D, gripper fingers 520A-B, 620A-B, 522A-B and 622A-B have an external contour 30, which allows the fingers to fit within sidewalls 14 of tray 104, when opposing pairs thereof are in the open position, just prior to grasping one or a pair of blocked lenses 129, that are held in tray 104. An exemplary gap between blade members 31 of fingers 520A-B and 522A-B, and those of opposing fingers 620A-B and 622A-B, respectively, is approximately 3 and ⅛ inches, when in the open position, and approximately 1 and ¼ inch, when in the closed position. These exemplary gaps are appropriate for particular perimeter dimensions of intermediate member 123 of mounting block assembly 125, in order to clear both the perimeter of member 123 and sidewalls 14 of tray 104, just prior to gripping (open position), and to grip around intermediate member 123 (closed position) with sufficient grasping force in order to transfer blocked lens 129. Of course the scope of the present invention is not limited by the exemplary gaps, as these gaps may vary according to alternative gripping locations on assembly 125 and/or according to alternative mounting block assembly dimensions.

FIG. 4A is a perspective view of spider assembly 156, which is shown isolated from the rest of the coating system, for clarity in illustration; and FIG. 4B is a side elevation view of one of spindle assemblies 130, which is adapted for mounting on any of arms 601 of spider assembly 156. FIG. 4A illustrates an axis 158 of spider assembly 156, about which spider assembly 156 rotates to position spindle assemblies 130, one mounted on each arm 601, at various processing stations of the coating system, as previously described in conjunction with FIG. 2. Spider assembly 156 and spindle assemblies 130, according to some embodiments of the present invention, are generally the same, in design and function, as those previously described in the aforementioned incorporated-by-reference published application WO2006/099012. However, rather than the previously described suction cups, the illustrated spindle assemblies 130 employ cups 45, of a different design, to hold blocked lenses 129. With reference to FIG. 4C, which is a cross-section view of one of cups 45 holding blocked lens 129, each cup 45 includes a rigid sidewall 451 and an O-ring type seal 43, which is mounted around an inner perimeter 453 of the rigid sidewall, according to some embodiments. Inner perimeter 453, together with seal 43, surround a bore, which receives one of the blocked lenses 129, as is illustrated in FIG. 4C. FIGS. 4B-C further illustrate each cup 45 mounted to a drive shaft 435, each of which causes the corresponding cup 45 to rotate, or spin, within some of the stations of the coating system, as was previously described in WO2006/099012. Also, as was previously described in WO2006/099012, each spindle assembly 130 may be connected to a vacuum source, and FIG. 4C illustrates shaft 435 including a lumen, or a conduit 437, through which a vacuum may be pulled to hold blocked lens 129 within cup 45 while spindle assembly 130 transfers blocked lens 129 to each processing station of the coating system; each spindle assembly 130 may also include vacuum sensors, similar to those previously described in WO2006/099012, in order detect how well each blocked lens 29 is held by cup 45.

FIG. 4D is a side elevation view of a portion of the lens coating system, according to some embodiments of the present invention, wherein gripper arm 500 is shown located at pick up position 164 (FIG. 2), and spindle assemblies 130 are shown raised above deck 162, after grippers 320, 322, have loaded each blocked lens 129 into the corresponding cup 45. According to some preferred embodiments of the present invention, the coating system includes a sensor assembly to detect whether a single blocked lens 129, or a pair of blocked lenses 129, is grasped by gripper assembly 300, for loading into each spindle assembly 130 at position 164. Instances, wherein gripper assembly 300 transfers a single blocked lens 129 into the system, may include those in which one of a pair of blocked lenses 129 is broken or otherwise lost, in prior processing, and those in which only a single lens is requested by customer, for example, in order to replace one of a pair of lenses that is already fitted into an eyeglass frame. These ‘single lens instances’ typically occur at random and may occur relatively infrequently.

FIG. 4D illustrates such a sensor assembly, which is adapted for blocked lens detection; the sensor assembly is shown including a pair of light sources 455, each of which is mounted from a bracket 452, and a reflector plate 450, which is positioned therebetween. According to the illustrated embodiment, light sources 455 and reflector plate 450 are positioned at pick up position 164, and are located at an elevation within the coating system, so that, as gripper arm 500 is being raised, per upstroke V, in order to load blocked lens(es) 129 into cup(s) 45, a beam of light, from each light source 455, will either be blocked from reflector plate 450, by the presence of blocked lens 129, which is grasped by one of grippers 320, 322, or will pass to reflector plate 450, in the absence of blocked lens 129. One example of a suitable sensor assembly for this application includes the Keyence #PZ2-61 Retro Reflective Sensor. It should be noted that alternative types of sensor assemblies, known to those skilled in the art, may be employed by alternate embodiments of the present invention, in order to detect a presence or absence of blocked lens 129 in each gripper 320, 322. For example, alternate mounting locations for the optical-type of sensors may be employed, or alternative types of sensors, such as force or proximity sensors, may be integrated into one or more of fingers 520A-B, 620A-B, and 522A-B, 622A-B of each gripper 320, 322. Furthermore, according to some alternate embodiments, each blocked lens 129 may be detected at that point, during loading, when gripper arm 500 reaches the upper end of upstroke V, and each blocked lens 129 has been inserted into the corresponding cup 45. With reference back to FIG. 4C, it may be appreciated that, according to these alternate embodiments, when blocked lens 129 is inserted into cup 45, a portion of mounting block assembly 125 protrudes from cup 45 for detection by an optical-type sensor assembly, like that described above.

According to preferred embodiments, the sensor assembly communicates with the spindle assembly 130, which is located at pick-up position 164, in order to activate vacuum for either one or a pair of cups 45, according to the detection. As was previously mentioned, above, in conjunction with FIG. 4C, each spindle assembly 130 may include a vacuum sensor for each cup 45; each spindle vacuum sensor can serve to confirm whether or not each blocked lens 129, that was detected in gripper assembly 300, during loading, has actually been inserted into the corresponding cup 45. According to those embodiments, which include the spindle vacuum sensors, these sensors preferably communicate with those processing stations of the lens coating system that include a pair of separate and independently activated compartments, one for each lens of a lens pair. The communication from one or both of the spindle vacuum sensors, for each spindle assembly 130, which would result when vacuum is activated for the associated cup 45, via the aforementioned communication from the sensor assembly, serves to activate, for processing, one or both of the compartments. According to some alternate embodiments, the sensor assembly that detects either a single blocked lens 129 or a pair of blocked lenses 129, being grasped by gripper assembly 300, communicates directly with those processing stations of the lens coating system that include a pair of separate and independently activated compartments, in order to activate, for processing, either one, or both, of the compartments, according to the detection. With further reference to FIG. 4D, a coating station 168 is shown including a pair of coating compartments 992, one or both of which will be activated for each spindle assembly 130, when each spindle assembly 130 moves around to station 168, according to whether one or a pair of blocked lenses 129 is loaded into each spindle assembly 130. For example, station 168 will be activated, by one or both of each pair of spindle vacuum sensors, or by the sensor assembly, to only pump coating material into one of compartments 992 when a spindle assembly 130, that holds a single blocked lens 129, arrives at station 168. The sensor assembly may be hard-wired to each spindle assembly 130 and/or coating station 168, for communication therewith, or wireless communication may be employed, either of which, according to methods known to those skilled in the art. An efficiency of lens handling, within the coating system, may be increased, by confirming the loading of a single lens into a spindle assembly, rather than a lens pair, and by only activating those portions of the system, which are necessary for processing the single lens.

Other sensor assemblies, which facilitate improved lens handling in the lens coating system, according to additional embodiments of the present invention, will now be described in conjunction with FIGS. 5A-B.

FIGS. 5A-B are a perspective view and a front elevation view of shuttle assembly 250, according to some embodiments; shuttle assembly 250 is shown isolated from the rest of the coating system, for clarity in illustration. FIGS. 5A-B illustrate shuttle assembly 250 including three lens holding elements: input platform 228 on which tray 104B rests, output platform 240, on which tray 104C rests, and a lens nest 244 mounted therebetween. As previously described, in conjunction with FIGS. 2 and 3C-D, gripper assembly 300 is mounted between platforms 228 and 240 in the lens coating system in order to transfer a single or pair of lenses from one of trays 104, when the tray is supported on input platform 228, to each spindle assemblies 130 of spider 156, for processing within the system, and then back to the same one of trays 104, when the tray is supported on output platform 240. Shuttle assembly 250 transfers each of trays 104, from input platform 228 to output platform 240, by lowering each tray 104, per arrow D, for example, being supported by inward facing lugs of four belts 55A, then laterally transferring each tray 104, per arrow E, for example, being supported by a conveyor belt 21, and then raising each tray 104, per arrow F, for example, being supported on similar lugs of another four belts 55B.

As was previously described in WO2006/099012, lens nest 244 provides a resting place for one or a pair of lenses, when gripper assembly 300, at first, misaligns the lens(es) within the corresponding cup 45 of spindle assembly 130, prior to processing, and, then, following processing, just prior to returning lens(es) back to the corresponding tray, at which time, lens nest 244 rotates the lens(es), in order that the lens(es) can be re-loaded, by gripper assembly 300, into a same position in the same tray 104 from which the lens(es) were taken. In some embodiments, the gripper assembly 300 can be programmed to automatically place every lens it grips into the lens nest 244 for re-gripping before transferring the lenses to the spider 156. Such embodiments can reduce the likelihood that the spider 156 will not be able to properly load the lens. In some embodiments, the gripper assembly 300 can be programmed to bypass the lens nest 244 and transfer lenses directly from the corresponding tray 104 to the spider 156. Such embodiments can provide increased throughput as compared with embodiments that make use of the lens nest 244. In some preferred embodiments, the gripper assembly 300 can be selectively programmed to either automatically place every lens it grips into the lens nest 244 for re-gripping before transferring the lenses to the spider 156 or bypass the lens nest 244 and transfer lenses directly from the corresponding tray 104 to the spider 156, depending on a variety of factors, such as the amount of debris (or lack thereof) in the corresponding tray 104.

In many instances, if the gripper assembly 300 were to transfer lenses directly from the spider 156 to the corresponding tray 104, the orientation of the lenses would be reversed—i.e., the lens that was conveyed into the lens coating system on the left side of the tray would then be on the right side and vice versa. In some embodiments, the gripper assembly 300 can transfer the lens(es) to the lens nest 244 after processing and the lens nest 244 can rotate 180-degrees to reorient the lens(es). The gripper assembly 300 can then re-grip the lens(es) for placement in the corresponding tray 104 in the proper orientation.

Some embodiments can provide for increased throughput by bypassing the lens nest 244 after processing, thereby freeing the lens nest 244 and the gripper assembly 300 for other activity while the lens(es) are being reoriented. The gripper assembly can transfer the lens(es) from the spider 156 to a reorientation assembly, which can reorient the lens(es) for placement in the corresponding tray 104.

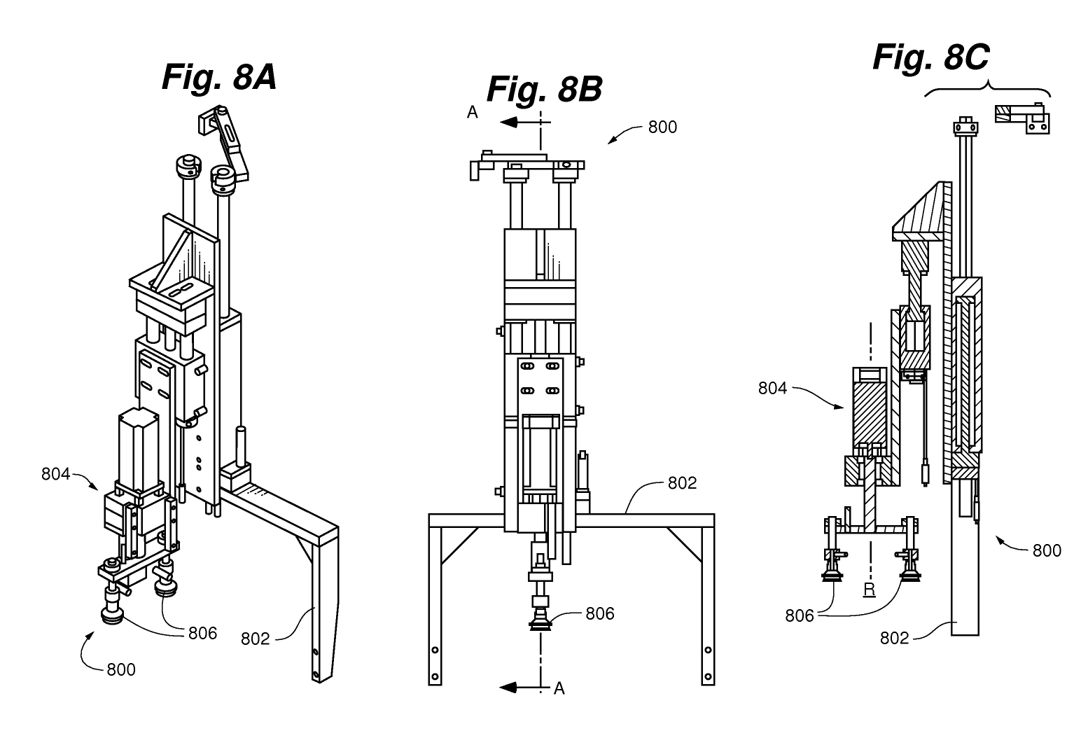

FIGS. 8A-8C show an illustrative reorientation assembly 800. The reorientation assembly 800 can include a base 802, which can be configured to be coupled to a suitable component of the lens coating system. The reorientation assembly 800 can include a lift-and-rotate mechanism 804, which can move vertically relative to the base 802 and can rotate about axis R. The gripper assembly can place one or two lenses in the corresponding tray directly below the lift-and-rotate mechanism 804, and the grippers 806 (which can have similar characteristics to other like components discussed herein) can lift the lens(es) from the tray. The lift-and-rotate mechanism 804 can rotate 180-degrees and set the lens(es) back into the tray for conveyance out of the lens coating system.

Although the illustrated configuration of shuttle assembly, and the operation thereof, in conjunction with gripper assembly 300 and spider 156 is preferred, it should be noted that alternate configurations may be employed by embodiments of the present invention.

According to the illustrated embodiment, both input platform 228 and lens nest 244 are each mounted to allow some vertical displacement thereof, if impinged upon. With respect to input platform 228, if tray 104 and/or lens(es) held therein are improperly positioned on input platform 228, gripper assembly 300 may impinge upon one or both of tray 104 and lens(es), when moving into proximity with lens(es), in order to grasp lens(es) for transfer to spindle assembly 130; alternately, or additionally, gripper arm 500 may be initially misaligned. With respect to lens nest 244, if lens nest 244 is not properly oriented to receive the lens(es) from gripper assembly 300 and/or if the lens(es), which are held in lens nest 244, having been transferred thereto from gripper assembly 300, are improperly oriented, gripper assembly 300, in attempting to transfer the lens(es) to nest 244, in the former instance, or in attempting to grasp the lens(es) that are held in lens nest 244, in the latter instance, may force nest 244 downward.

One or more displacement sensor assemblies can be incorporated into the lens coating system in order to prevent damage to the gripper assembly 300 stemming from improperly pressing against the input platform 228, the lens nest 244, and/or the spider 156. FIGS. 5A-B illustrate a displacement sensor assembly for input platform 228 including a light source 51 and a receiver 53, which are located on opposite sides of a sidewall 58 of platform 228; sidewall 58 includes an aperture (not seen) through which a beam of light from light source 51 may pass to hit receiver 53, if input platform 228 is not displaced. Thus, when platform 228 is displaced, the beam of light is blocked by sidewall 58 so that the sensor assembly detects the displacement. An example of a suitable sensor assembly for this application includes a Keyence #FS-V22R Fiber Optic Amplifier, a Keyence #FU-77V Fiber Optic Pair, and a Keyence #F-4 Lens (distance magnification).

FIG. 5A further illustrates lens nest 244 being supported by a spring-mounted platform 504, and another displacement sensor assembly, which includes a light source 514 and a receiver 534. According to the illustrated embodiment, if lens nest 244 is displaced by impingement by gripper assembly 300, platform 504 will move downward to block the beam of light from light source 514 so that the sensor assembly detects the displacement. An example of a suitable sensor assembly for this application includes a Keyence #FS-V22R Fiber Optic Amplifier and a Keyence #FU-77V Fiber Optic Pair.

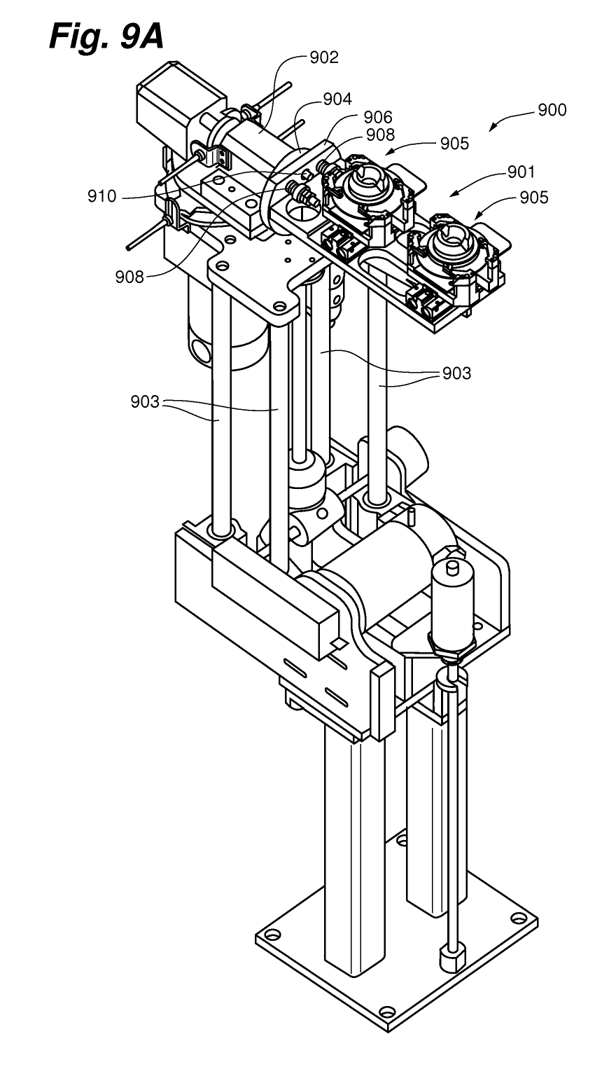

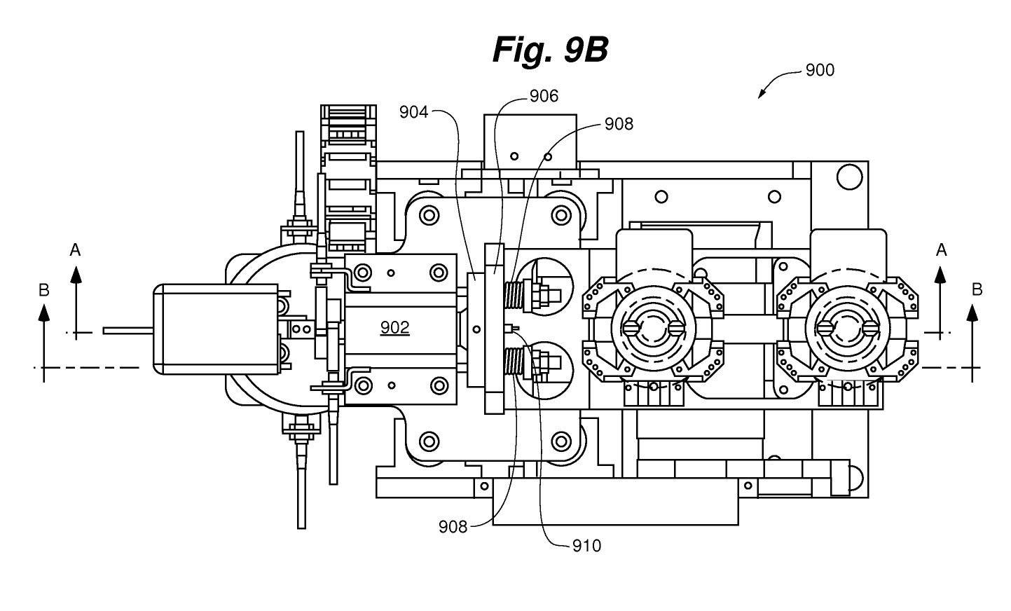

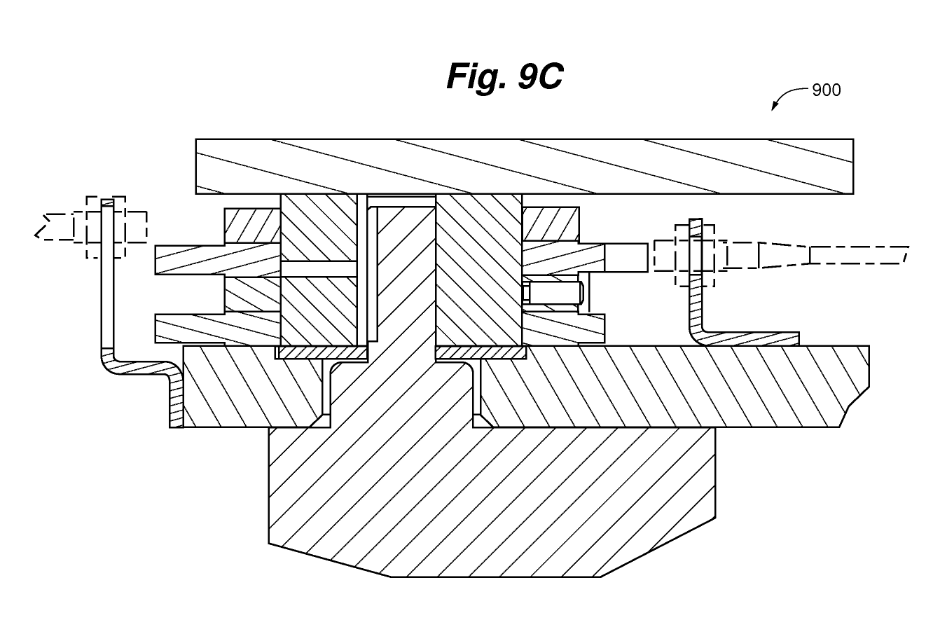

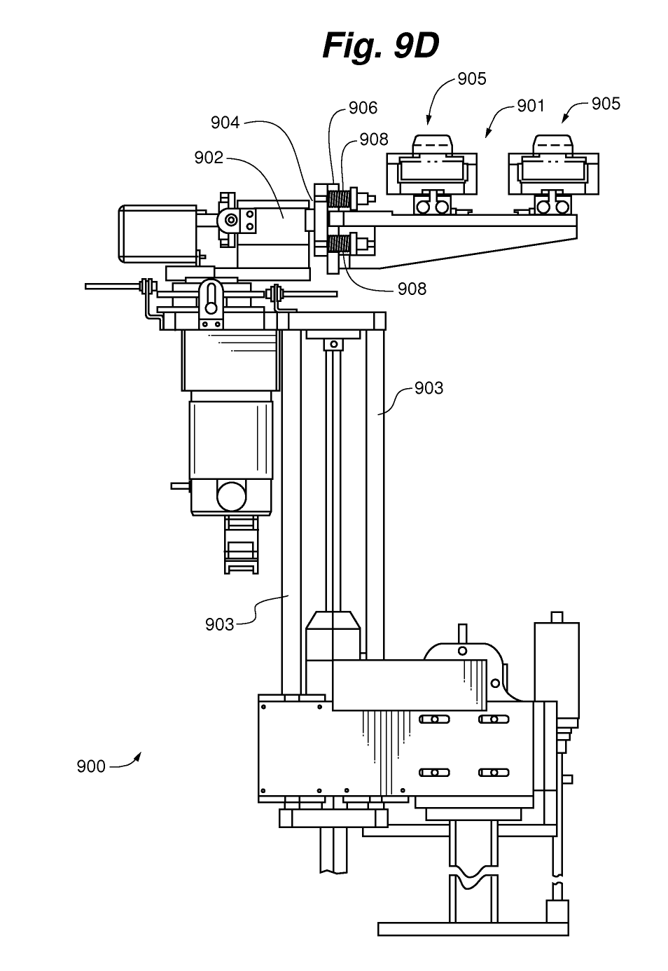

In some embodiments, the In some embodiments, the gripper assembly 300 itself can include a displacement sensor assembly. FIGS. 9A-D show an illustrative gripper assembly 900 that includes an illustrative displacement sensor assembly. As is discussed elsewhere herein, the cantilever arm 901 can be configured to rotate relative to shaft 902, and the entire mechanism that includes the cantilever arm 901 and the shaft 902 can be configured to travel along rails 903. When such mechanism is positioned proximate the input platform, the nest, or the spider so that the grippers can grasp or release one or more lenses, unwanted vertical force can be exerted on the cantilever arm 901 (e.g., due to a misaligned lens triggering the machine to continue pressing the upper mechanism closer to the input platform, nest, or spider). In embodiments lacking a displacement sensor assembly, the cantilever arm 901 and/or the shaft 902 can become bent as a result of such unwanted vertical force, thereby significantly impeding performance of the gripper assembly. Such embodiments often implement a shaft with a relatively small diameter because it is easier to replace/repair a bent shaft than a bent cantilever arm. The gripper assembly 900 of FIGS. 9A-D includes a displacement sensor assembly and a relatively larger diameter shaft 902. The displacement sensor assembly includes a shaft plate 904, an arm plate 906, a biasing mechanism 908, and a sensor 910. The biasing mechanism 908 (e.g., one or more compression springs and associated hardware) can bias the arm plate 906 against the shaft plate. If unwanted vertical force is exerted on the cantilever arm 901, the arm plate 906 will tend to separate from the shaft plate 904. Upon such separation, sensor 910 (e.g., a magnetic sensor) can detect the displacement.

One or more displacement sensor assemblies can be incorporated into a lens coating system. Some lens coating systems can include a displacement sensor assembly incorporated into the input platform and/or the lens nest and/or the gripper assembly. Some embodiments can include a displacement sensor assembly incorporated into the spider instead of, or in addition to, one or more of the displacement sensor assemblies discussed herein.

With reference back to FIG. 1, control panel 43 may alert an operator of the system when displacement is detected. For example, according to some embodiments, in response to a first detection of the displacement of input platform 228, the system will re-orient gripper arm 500 for a second attempt at grasping the lens(es) held in tray 104 on input platform 228; if displacement is detected again, the operator will be alerted, for example, via control panel 43. The operator may find that tray 104 was improperly positioned and/or contains extraneous matter causing interference with gripper arm 500, and/or that one or a pair of lenses was improperly loaded into tray 104. As was previously described for the sensor assembly shown in FIG. 4D, the sensor assemblies described in conjunction with FIGS. 5A-B and 9A-D may be hard-wired to control panel 43, or adapted for wireless communication therewith.

As previously described, in conjunction with FIG. 3A, bar code tag 124, which is attached to tray 104, may provide information to the processing stations of the coating system concerning processing parameters for the lens(es) held within tray 104. FIGS. 5A-B further illustrate a bar code scanner 582, for example, model #CLV-422-1010, available from SICK, which is mounted to shuttle assembly 250, in proximity to input platform 228, so as to read and transfer information from tag 124 to one or more processing stations of the lens coating system.

As was mentioned above, in conjunction with FIG. 4D, lens coating station 168 of the system includes a pair of coating compartments 992. Turning now to FIG. 6A, a perspective view of one of compartments 992 is shown. FIG. 6A illustrates compartment 992 including a tank 905 in which a nozzle (not shown) directs a stream, or fountain, of coating material onto a lens, which is positioned, by one of spindle assemblies 130, in tank 905; the coating material is fed through a tube 960 and into a reservoir 904 of tank 905, in which the nozzle is mounted. The function of compartment 992 may be very similar to that described for a corresponding coating station element in the incorporated-by-reference patent publication WO2006/099012, with the exception that, rather than the previously described digital optical sensors, that were mounted on opposing sides of tank 905 to detect when the coating material is not flowing properly, coating station 168 incorporates a flow meter downstream of each tank 905. FIG. 6B is a perspective view of a flow meter 965, which may be connected in-line with tube 960 to monitor the flow of coating material into reservoir 904, according to some embodiments of the present invention. One example of a suitable flow meter for this application is a 4.9 GPM, Sight-tube type, PTFE/Glass Flow Meter, model #VA15019, available from Dwyer. FIG. 6B illustrates flow meter 965 including a ball element 971 contained in a transparent column 970, which is mounted in a housing 980; column 970 defines a channel through which the coating material flows, prior to entering reservoir 904. According to FIG. 6B, the flow of coating material causes ball element 971 to rise to a level coincident with an aperture 981, which is formed in a sidewall of housing 980, so that a light beam, which is sent by a light source (not shown), through aperture 981, is blocked from detection by a receiver (not shown), which is located on an opposite side of housing 980 and is aligned with a similar aperture formed in the opposing sidewall of housing 980.

Following coating, for example, within station 168, each lens or lens pair is transferred, via the corresponding spindle assembly 130, to a curing station. FIGS. 7A-B are a perspective view and a side elevation view of an exemplary curing station 172 of the lens coating system (-shown isolated from the rest of the coating system, for clarity in illustration). The illustrated curing station 172 is set up in a similar fashion to the curing station described in the incorporated-by-reference application WO2006/099012, such that the coated surface of each lens, that is held by one of spindle assemblies 130, and lowered thereby into one of sleeve openings 792, in a sidewall of station 172, is exposed to radiation, that is emitted from an ultraviolet (UV) lamp 220, for curing. As was previously described in WO2006/099012, lamp 220 is mounted within the station to pivot back and forth, per arrow B, while spindle assembly 130 rotates the lens(es) for the curing process. Curing station 172 differs from that previously described in WO2006/099012 in that a pair of fans 710 are incorporated, rather than a single fan, and fans 710 are mounted on an opposite side of lamp 220 from an air inlet duct 716, being better positioned to draw a cooling flow of air around lamp 220, from inlet duct 716, without forcing the air flow against each lens, that is positioned in one of sleeves 792, above lamp 220.

In some embodiments, a lens handling method performed by a lens coating system comprises (a) grasping at least one blocked lens, which is held in a tray, the at least one blocked lens comprising a mounting block assembly coupled to a first major surface of a lens, the tray being located at a first location in the system, and the grasping being performed by a gripper assembly of the system to transfer the at least one blocked lens; (b) transferring, via the gripper assembly, the at least one blocked lens from the tray to a second location in the system, which second location is located for loading the at least one blocked lens into a spindle assembly of the system; (c) loading the at least one blocked lens into the spindle assembly for transfer into and out from a lens coating station of the system; (d) detecting a presence of the at least one blocked lens at the second location, as the at least one blocked lens is being loaded into the spindle assembly, the detecting being performed by a sensor assembly of the system, and the detecting determining if the at least one blocked lens comprises a single blocked lens or a pair of blocked lenses; and (e) activating the lens coating station based upon the determination of whether the at least one blocked lens comprises the single blocked lens or the pair of blocked lenses, wherein the sensor assembly of the system comprises at least one light source that projects a light beam to detect the at least one blocked lens; and the detection is affected by each mounting block assembly, of the at least one blocked lens, crossing a path of the projected light beam, when the at least one blocked lens is grasped by opposing fingers of the gripper assembly, as the fingers move upward, at the second location, to load the at least one blocked lens into the spindle assembly.

In some embodiments, a lens coating system comprises (a) a lens coating station; (b) a spindle assembly adapted for transferring a single blocked lens or a pair of blocked lenses into and out from the lens coating station, the spindle assembly including a first cup and a second cup, each of the first and second cups being adapted to hold one of the blocked lenses, via a vacuum, and each of the blocked lenses comprising a mounting block assembly coupled to a first major surface of a lens; (c) a gripper assembly adapted for transferring the single blocked lens or the pair of blocked lenses from a tray, which tray is located at a first position in the system, to a second position in the system, and then loading the single blocked lens or the pair of blocked lenses into the spindle assembly, at the second position, the gripper assembly including a first gripper and a second gripper, and each of the first and second grippers being adapted to grasp one of the blocked lenses; and (d) a sensor assembly adapted to detect a presence or an absence of each of the blocked lenses at the second position, during the loading, the sensor assembly being coupled to the spindle assembly for activating the vacuum, based upon whether the single blocked lens or the pair of the blocked lenses is detected, wherein the sensor assembly comprises a reflector plate, a first light source and a second light source, the reflector plate being located in between the first and second cups of the spindle assembly at the second position, the first light source being located on a first side of the reflector plate, to direct a beam of light toward the reflector plate.

In some embodiments, a lens coating system comprises (a) a lens coating station; (b) a spindle assembly adapted for transferring a single blocked lens or a pair of blocked lenses into and out from the lens coating station, the spindle assembly including a first cup and a second cup, each of the first and second cups being adapted to hold one of the blocked lenses, via a vacuum, and each of the blocked lenses comprising a mounting block assembly coupled to a first major surface of a lens; (c) a gripper assembly adapted for transferring the single blocked lens or the pair of blocked lenses from a tray, which tray is located at a first position in the system, to a second position in the system, and then loading the single blocked lens or the pair of blocked lenses into the spindle assembly, at the second position, the gripper assembly including a first gripper and a second gripper, and each of the first and second grippers being adapted to grasp one of the blocked lenses; and (d) a sensor assembly adapted to detect a presence or an absence of each of the blocked lenses at the second position, during the loading, the sensor assembly being coupled to the spindle assembly for activating the vacuum, based upon whether the single blocked lens or the pair of the blocked lenses is detected, wherein each of the first and second cups of the spindle assembly comprises a rigid sidewall and an O-ring type seal mounted around an inner perimeter of the rigid sidewall, the inner perimeter and the seal surrounding a bore for receiving one of the loaded blocked lenses.

In some embodiments, a lens coating system comprises (a) a lens coating station; (b) a spindle assembly adapted for transferring a single blocked lens or a pair of blocked lenses into and out from the lens coating station, the spindle assembly including a first cup and a second cup, each of the first and second cups being adapted to hold one of the blocked lenses, via a vacuum, and each of the blocked lenses comprising a mounting block assembly coupled to a first major surface of a lens; (c) a gripper assembly adapted for transferring the single blocked lens or the pair of blocked lenses from a tray, which tray is located at a first position in the system, to a second position in the system, and then loading the single blocked lens or the pair of blocked lenses into the spindle assembly, at the second position, the gripper assembly including a first gripper and a second gripper, and each of the first and second grippers being adapted to grasp one of the blocked lenses; and (d) a sensor assembly adapted to detect a presence or an absence of each of the blocked lenses at the second position, during the loading, the sensor assembly being coupled to the spindle assembly for activating the vacuum, based upon whether the single blocked lens or the pair of the blocked lenses is detected, wherein the lens coating station includes a pair of tanks, a pair of corresponding tubes for feeding coating material into the tanks, and a pair of flow meters; each of the pair of flow meters is connected in-line with one of the pair of tubes, for monitoring a flow of coating material therethrough; and each of the pair of tanks is adapted to receive one of the blocked lenses that is transferred into the lens coating station by the spindle assembly.

In some embodiments, a lens coating system comprises (a) a lens coating station; (b) a spindle assembly adapted for transferring a single blocked lens or a pair of blocked lenses into and out from the lens coating station, the spindle assembly including a first cup and a second cup, each of the first and second cups being adapted to hold one of the blocked lenses, via a vacuum, and each of the blocked lenses comprising a mounting block assembly coupled to a first major surface of a lens; (c) a gripper assembly adapted for transferring the single blocked lens or the pair of blocked lenses from a tray, which tray is located at a first position in the system, to a second position in the system, and then loading the single blocked lens or the pair of blocked lenses into the spindle assembly, at the second position, the gripper assembly including a first gripper and a second gripper, and each of the first and second grippers being adapted to grasp one of the blocked lenses; and (d) a sensor assembly adapted to detect a presence or an absence of each of the blocked lenses at the second position, during the loading, the sensor assembly being coupled to the spindle assembly for activating the vacuum, based upon whether the single blocked lens or the pair of the blocked lenses is detected, further comprising (e) a curing station including a sidewall and an UV lamp, the UV lamp being contained within the sidewall and directed toward an opening of the sidewall; (f) wherein the spindle assembly is further adapted for transferring one of the blocked lenses into and out from the curing station, through the opening of the sidewall, after transferring the blocked lens into and out from the lens coating station; and (g) the curing station further includes an air inlet duct and a pair of fans, the fans being mounted on an opposite side of the UV lamp from the air inlet duct, in order to draw air flow from the opening, past the UV lamp.

In some embodiments, a lens coating system comprises (a) a first lens-holding element; (b) a second lens-holding element; (c) a lens coating station; (d) a spindle assembly adapted for transferring a lens into and out from the coating station; (e) a gripper assembly adapted for transferring the lens from the first lens-holding element, loading the lens into the spindle assembly, and transferring the lens from the spindle assembly to the second lens-holding element; and (f) a sensor assembly adapted to detect a displacement of one of the first and second lens-holding elements, the displacement being caused by the gripper assembly impinging upon one or both of: the one of the first and second lens-holding elements and the lens being held therein, wherein (i) the first lens-holding element comprises a tray and an input platform of the system, on which the tray rests; (ii) the sensor assembly detects displacement of the input platform; (iii) the sensor assembly comprises a light source, a receiver and an aperture formed through a sidewall of the input platform; (iv) the light source projects a beam, through the aperture, to the receiver, when the input platform is not displaced; and (v) the projected light beam is blocked by the sidewall of the input platform, when the input platform is displaced.

In some embodiments, a lens coating system comprises (a) a first lens-holding element; (b) a second lens-holding element; (c) a lens coating station; (d) a spindle assembly adapted for transferring a lens into and out from the coating station; (e) a gripper assembly adapted for transferring the lens from the first lens-holding element, loading the lens into the spindle assembly, and transferring the lens from the spindle assembly to the second lens-holding element; and (f) a sensor assembly adapted to detect a displacement of one of the first and second lens-holding elements, the displacement being caused by the gripper assembly impinging upon one or both of: the one of the first and second lens-holding elements and the lens being held therein, wherein (i) the second lens-holding element comprises a lens nest of the system and a platform of the system, on which the lens nest is mounted; (ii) the sensor assembly detects displacement of the platform; (iii) the sensor assembly comprises a light source and a receiver, the light source and the receiver being positioned opposite one another on either side of the platform; (iv) the light source projects a beam, beneath the platform, to the receiver, when the platform is not displaced; and (v) the projected light beam is blocked by the displaced platform.

In some embodiments, a lens coating system comprises (a) a first lens-holding element; (b) a second lens-holding element; (c) a lens coating station; (d) a spindle assembly adapted for transferring a lens into and out from the coating station; (e) a gripper assembly adapted for transferring the lens from the first lens-holding element, loading the lens into the spindle assembly, and transferring the lens from the spindle assembly to the second lens-holding element; and (f) a sensor assembly adapted to detect a displacement of one of the first and second lens-holding elements, the displacement being caused by the gripper assembly impinging upon one or both of: the one of the first and second lens-holding elements and the lens being held therein, wherein (i) the lens coating station includes a tank, a tube for feeding coating material into the tank, and a flow meter connected in-line with the tube for monitoring a flow of coating material therethrough; and (ii) the tank is adapted to receive the lens that is transferred into the lens coating station by the spindle assembly.

In some embodiments, a lens coating system comprises (a) a first lens-holding element; (b) a second lens-holding element; (c) a lens coating station; (d) a spindle assembly adapted for transferring a lens into and out from the coating station; (e) a gripper assembly adapted for transferring the lens from the first lens-holding element, loading the lens into the spindle assembly, and transferring the lens from the spindle assembly to the second lens-holding element; and (f) a sensor assembly adapted to detect a displacement of one of the first and second lens-holding elements, the displacement being caused by the gripper assembly impinging upon one or both of: the one of the first and second lens-holding elements and the lens being held therein, wherein (i) a mounting block assembly is coupled to a first major surface of the lens; (ii) the spindle assembly comprises a cup; and (iii) the cup of the spindle assembly comprises a rigid sidewall and an O-ring type seal mounted around an inner perimeter of the rigid sidewall, the inner perimeter and the seal surrounding a bore for receiving the mounting block assembly of the loaded lens.

In some embodiments, a lens coating system comprises (a) a first lens-holding element; (b) a second lens-holding element; (c) a lens coating station; (d) a spindle assembly adapted for transferring a lens into and out from the coating station; (e) a gripper assembly adapted for transferring the lens from the first lens-holding element, loading the lens into the spindle assembly, and transferring the lens from the spindle assembly to the second lens-holding element; and (f) a sensor assembly adapted to detect a displacement of one of the first and second lens-holding elements, the displacement being caused by the gripper assembly impinging upon one or both of: the one of the first and second lens-holding elements and the lens being held therein, further comprising (g) a curing station including a sidewall and an UV lamp, the UV lamp being contained within the sidewall and directed toward an opening of the sidewall; (h) wherein the spindle assembly is further adapted for transferring the lens into and out from the curing station, through the opening of the sidewall, after transferring the lens into and out from the lens coating station; and (i) the curing station further includes an air inlet duct and a pair of fans, the fans being mounted on an opposite side of the UV lamp from the air inlet duct, in order to draw air flow from the opening, past the UV lamp.

In the foregoing detailed description, the invention has been described with reference to specific embodiments. However, it may be appreciated that various modifications and changes can be made without departing from the scope of the invention as set forth in the appended claims.

1. A lens handling method performed by a lens coating system, the method comprising:
grasping at least one blocked lens, which is held in a tray, the at least one blocked lens comprising a mounting block assembly coupled to a first major surface of a lens, the tray being located at a first location in the system, and the grasping being performed by a gripper assembly of the system to transfer the at least one blocked lens;
transferring, via the gripper assembly, the at least one blocked lens from the tray to a second location in the system, which second location is located for loading the at least one blocked lens into a spindle assembly of the system;
loading the at least one blocked lens into the spindle assembly for transfer into and out from a lens coating station of the system;
detecting a presence of the at least one blocked lens at the second location, as the at least one blocked lens is being loaded into the spindle assembly, the detecting being performed by a sensor assembly of the system, and the detecting determining if the at least one blocked lens comprises a single blocked lens or a pair of blocked lenses;
activating the lens coating station based upon the determination of whether the at least one blocked lens comprises the single blocked lens or the pair of blocked lenses.

2. The method of claim 1, wherein:
the at least one blocked lens comprises the single blocked lens; and
the gripper assembly includes a first gripper and a second gripper, located alongside the first gripper, the first gripper being employed to grasp and to transfer the single blocked lens and the second gripper being unemployed for grasping and transferring.

3. The method of claim 1, wherein:
the at least one blocked lens comprises the single blocked lens;
the lens coating station includes a pair of compartments; and
activating the lens coating station comprises pumping coating material into only one of the pair of compartments.

4. The method of claim 1, further comprising activating a vacuum for the spindle assembly, to hold the at least one blocked lens, based upon the determination of whether the at least one blocked lens comprises the single blocked lens or the pair of blocked lenses.

5. The method of claim 1, wherein:
the sensor assembly of the system comprises at least one light source that projects a light beam to detect the at least one blocked lens; and
the detection is affected by each mounting block assembly, of the at least one blocked lens, crossing a path of the projected light beam, when the at least one blocked lens is grasped by opposing fingers of the gripper assembly, as the fingers move upward, at the second location, to load the at least one blocked lens into the spindle assembly.

6. The method of claim 1, further comprising:
detecting a displacement of an input platform of the system, which platform holds the tray at the first location, the displacement being caused by the gripper assembly impinging upon at least one of: the tray and the at least one blocked lens, when the tray and/or the at least one blocked lens have/has been improperly positioned at the first location, and the detecting being performed by another sensor assembly of the system; and
repositioning the tray and/or the at least one blocked lens into a proper position at the first location, after detecting the displacement and prior to grasping the at least one blocked lens.

7. The method of claim 1, further comprising:
detecting a displacement of an input platform of the system, which platform holds the tray at the first location, the displacement being caused by the gripper assembly impinging upon at least one of: the tray and the at least one blocked lens, when the tray and/or the at least one blocked lens have/has been improperly positioned at the first location, and the detecting being performed by another sensor assembly of the system; and
repositioning the gripper assembly, after detecting the displacement and prior to grasping the at least one blocked lens.

8. The method of claim 1, further comprising:
detecting the displacement of an arm of the gripper assembly on which one or more grippers are mounted, the displacement being caused by the gripper assembly impinging on at least one of: an input platform of the system, a lens nest of the system, and a spider assembly of the system; and
repositioning the gripper assembly upon detection of the displacement.

9. The method of claim 1, further comprising:
transferring, via the spindle assembly, the at least one blocked lens into and out from the lens coating station;
unloading the at least one blocked lens from the spindle assembly by releasing the at least one blocked lens back into the grasp of the gripper assembly, at the second location, for transferring into a lens nest of the system;
detecting a displacement of the lens nest, the displacement being caused by the gripper assembly impinging upon the lens nest;
repositioning at least one of: the lens nest and the at least one blocked lens within the grasp of the gripper assembly; and
transferring the at least one blocked lens into the lens nest, after the repositioning.

10. The method of claim 1, further comprising:
transferring, via the spindle assembly, the at least one blocked lens into and out from the lens coating station;
unloading the at least one blocked lens from the spindle assembly by releasing the at least one blocked lens back into the grasp of the gripper assembly, at the second location,
transferring the at least one blocked lens to the tray with the gripper assembly;
gripping and reorienting the at least one blocked lens with a reorientation assembly;
placing the at least one blocked lens back into the tray with the reorientation assembly.

11. A lens coating system, comprising:
a lens coating station;
a spindle assembly adapted for transferring a single blocked lens or a pair of blocked lenses into and out from the lens coating station, the spindle assembly including a first cup and a second cup, each of the first and second cups being adapted to hold one of the blocked lenses, via a vacuum, and each of the blocked lenses comprising a mounting block assembly coupled to a first major surface of a lens;
a gripper assembly adapted for transferring the single blocked lens or the pair of blocked lenses from a tray, which tray is located at a first position in the system, to a second position in the system, and then loading the single blocked lens or the pair of blocked lenses into the spindle assembly, at the second position, the gripper assembly including a first gripper and a second gripper, and each of the first and second grippers being adapted to grasp one of the blocked lenses; and
a sensor assembly adapted to detect a presence or an absence of each of the blocked lenses at the second position, during the loading, the sensor assembly being coupled to the spindle assembly for activating the vacuum, based upon whether the single blocked lens or the pair of the blocked lenses is detected.

12. The system of claim 11, wherein the gripper assembly is selectively programmable to transfer the single blocked lens or the pair of blocked lenses (a) from the tray to a lens nest for re-gripping before transfer to the second position or (b) from the tray directly to the second position.

13. The system of claim 11, wherein the sensor assembly comprises a reflector plate, a first light source and a second light source, the reflector plate being located in between the first and second cups of the spindle assembly at the second position, the first light source being located on a first side of the reflector plate, to direct a beam of light toward the reflector plate.

14. The system of claim 11, wherein each of the first and second cups of the spindle assembly comprises a rigid sidewall and an O-ring type seal mounted around an inner perimeter of the rigid sidewall, the inner perimeter and the seal surrounding a bore for receiving one of the loaded blocked lenses.

15. The system of claim 11, wherein:
the lens coating station includes a pair of tanks, a pair of corresponding tubes for feeding coating material into the tanks, and a pair of flow meters;
each of the pair of flow meters is connected in-line with one of the pair of tubes, for monitoring a flow of coating material therethrough; and
each of the pair of tanks is adapted to receive one of the blocked lenses that is transferred into the lens coating station by the spindle assembly.

16. The system of claim 11, further comprising:
a curing station including a sidewall and an UV lamp, the UV lamp being contained within the sidewall and directed toward an opening of the sidewall;
wherein the spindle assembly is further adapted for transferring one of the blocked lenses into and out from the curing station, through the opening of the sidewall, after transferring the blocked lens into and out from the lens coating station; and
the curing station further includes an air inlet duct and a pair of fans, the fans being mounted on an opposite side of the UV lamp from the air inlet duct, in order to draw air flow from the opening, past the UV lamp.

17. The system of claim 11, further comprising:
a shuttle assembly including an input platform, the input platform adapted for holding the tray at the first location; and
another sensor assembly adapted to detect a vertical displacement of the input platform.

18. The system of claim 11, further comprising:
a lens nest adapted for holding the single blocked lens or the pair of blocked lenses; and
another sensor assembly adapted to detect a vertical displacement of the lens nest;
wherein the gripper assembly is further adapted to receive back, from the spindle assembly, and to transfer, to the lens nest, the single blocked lens or the pair of blocked lenses.

19. The system of claim 11, wherein the gripper assembly further includes a shaft coupled to an arm, with the first and second grippers being mounted to the arm, and wherein the system further comprises another sensor assembly adapted to detect separation of the arm from the shaft.

20. The system of claim 11, further comprising a reorientation assembly adapted to grasp the single blocked lens or the pair of blocked lenses after processing, reorient the single blocked lens or the pair of blocked lenses, and place the single blocked lens or the pair of blocked lenses into the tray.

21. A lens handling method performed by a lens coating system, the method comprising:
detecting a displacement of a lens-holding element, the displacement being caused by a gripper assembly impinging upon one or both of: the lens-holding element and a lens being held by the element;
repositioning at least one of: the lens-holding element, the lens, and the gripper assembly; and
transferring, via the gripper assembly, the lens either from the lens holding element to a spindle assembly of the system, or from the spindle assembly to the lens-holding element, after the repositioning.

22. The method of claim 21, wherein:
the lens-holding element comprises a tray and an input platform of the system, on which the tray rests;
the repositioning is of one or both of: the tray and the lens; and
the transferring of the lens is from the tray to a spindle assembly of the system, for subsequent transfer to a lens coating station of the system.

23. The method of claim 21, wherein:
the lens-holding element comprises a tray and an input platform of the system, on which the tray rests;
the repositioning is of the gripper assembly; and
the transferring of the lens is from the tray to a spindle assembly of the system, for subsequent transfer to a lens coating station of the system.

24. The method of claim 21, further comprising:
transferring the lens from a spindle assembly of the system to the gripper assembly, the spindle assembly having previously transferred the lens into and out from a lens coating station of the system;
wherein the lens-holding element comprises a lens nest;
the repositioning is of the lens nest; and
the transferring of the at least one lens is from the gripper assembly to the lens nest.

25. The method of claim 21, further comprising:
transferring the lens from a spindle assembly of the system to the gripper assembly, the spindle assembly having previously transferred the lens into and out from a lens coating station of the system;
wherein the lens-holding element comprises a lens nest;
the repositioning is of the gripper assembly; and
the transferring of the lens is from the gripper assembly to the lens nest.

26. A lens coating system, comprising:
a first lens-holding element;
a second lens-holding element;
a lens coating station;
a spindle assembly adapted for transferring a lens into and out from the coating station;
a gripper assembly adapted for transferring the lens from the first lens-holding element, loading the lens into the spindle assembly, and transferring the lens from the spindle assembly to the second lens-holding element; and
a sensor assembly adapted to detect a displacement of one of the first and second lens-holding elements, the displacement being caused by the gripper assembly impinging upon one or both of: the one of the first and second lens-holding elements and the lens being held therein.

27. The system of claim 26, wherein:
the first lens-holding element comprises a tray and an input platform of the system, on which the tray rests; and
the sensor assembly detects displacement of the input platform.

28. The system of claim 27, wherein:
the sensor assembly comprises a light source, a receiver and an aperture formed through a sidewall of the input platform;
the light source projects a beam, through the aperture, to the receiver, when the input platform is not displaced; and
the projected light beam is blocked by the sidewall of the input platform, when the input platform is displaced.

29. The system of claim 26, wherein:
the second lens-holding element comprises a lens nest of the system and a platform of the system, on which the lens nest is mounted; and
the sensor assembly detects displacement of the platform.

30. The system of claim 29, wherein:
the sensor assembly comprises a light source and a receiver, the light source and the receiver being positioned opposite one another on either side of the platform;
the light source projects a beam, beneath the platform, to the receiver, when the platform is not displaced; and
the projected light beam is blocked by the displaced platform.

31. The system of claim 26, further comprising another sensor assembly adapted to detect a displacement of another of the first and second lens-holding elements, the displacement being caused by the gripper assembly impinging upon one or both of: the other of the first and second lens-holding elements and the lens being held therein.

32. The system of claim 31, wherein:
the first lens-holding element comprises a tray and an input platform of the system, on which the tray rests, and the sensor assembly detects displacement of the input platform; and
the second lens-holding element comprises a lens nest of the system and a platform of the system, on which the lens nest is mounted, and the other sensor assembly detects displacement of the platform.

33. The system of claim 26, wherein:
the lens coating station includes a tank, a tube for feeding coating material into the tank, and a flow meter connected in-line with the tube for monitoring a flow of coating material therethrough; and
the tank is adapted to receive the lens that is transferred into the lens coating station by the spindle assembly.

34. The system of claim 26, wherein:
a mounting block assembly is coupled to a first major surface of the lens;
the spindle assembly comprises a cup; and
the cup of the spindle assembly comprises a rigid sidewall and an O-ring type seal mounted around an inner perimeter of the rigid sidewall, the inner perimeter and the seal surrounding a bore for receiving the mounting block assembly of the loaded lens.

35. The system of claim 26, further comprising:
a curing station including a sidewall and an UV lamp, the UV lamp being contained within the sidewall and directed toward an opening of the sidewall;
wherein the spindle assembly is further adapted for transferring the lens into and out from the curing station, through the opening of the sidewall, after transferring the lens into and out from the lens coating station; and
the curing station further includes an air inlet duct and a pair of fans, the fans being mounted on an opposite side of the UV lamp from the air inlet duct, in order to draw air flow from the opening, past the UV lamp.
